(19) United States
(12) Patent Application Publication
(10) Pub. No.: US 2008/0065423 A1
(43) Pub. Date: Mar. 13, 2008

(54) IMAGE USE HISTORY MANAGEMENT SYSTEM, MODALITY, AND SERVER

(76) Inventors: Yoshihiro Oda, Tokyo (JP); Takuya Kawamura, Tokyo (JP)

Correspondence Address: Patrick W. Rasche;Armstrong Teasdale LLP, Suite 2600, One Metropolitan Square, St. Louis, MO, 63102, US

(21) Appl. No.: 11/850,902

(22) Filed: Sep. 6, 2007

(30) Foreign Application Priority Data
Sep. 7, 2006 (JP) 2006-242597

(51) Int. Cl. G06Q 50/00

(52) U.S. Cl. 705/3

(57) ABSTRACT

An image use history management system is provided, in which each time an image is used, the use is additionally written in use history information. At the time of generating an image, a modality generates use history information of the image. When the image is subjected to a process such as transmission, erasure, recording to an external recording medium, and erasure of patient information from the image, the modality and a server additionally write information corresponding to the process in the use history information and store the resultant information so as to be associated with the image.

### CROSS REFERENCE TO RELATED APPLICATIONS

This application claims the benefit of Japanese Application No. 2006-242597 filed Sep. 7, 2006.

### BACKGROUND OF THE INVENTION

The present invention relates to an image use history management system, a modality, and a server for generating and managing an image for medical treatment.

In recent years, digitization of images for medical treatment is being developed. For example, an image can be stored in a standard of DICOM (Digital Imaging and Communication in Medicine) and freely transmitted via a network or a medium. Such an image for medical treatment is an image captured by a modality such as MRI (Magnetic Resonance Imaging), CT (Computed Tomography), or ultrasonic diagnostic apparatus. The captured image together with test information and personal information of the patient is managed by a picture archiving communication system (PACS) in a centralized manner.

Digital image management systems as described above are configured in medical institutions and each of the medical institutions has many servers. With the configuration, a desired image can be viewed in any place in a medical institute and, in addition, can be transmitted to a place other than the medical institute via a network.

Such a system, however, has a drawback such that it is difficult to accurately monitor and manage transmission of images. Since transmission of images and recording of images to media (such as MO and DVD) is not controlled by the whole system, management of transmission and recording of an image is left to processes of users. The system has a drawback such that there is no means to know how an image transmitted to another server in a system is used after transmission (for example, the image was transmitted to further another server, recorded, or the like), and images cannot be perfectly managed.

There is another drawback such that, since diagnosis information and personal information of a patient is attached to an image, due to imperfect management of images, the personal information of patients may be leaked.

### SUMMARY OF THE INVENTION

It is desirable that the problems described previously are solved.

One aspect of the invention provides an image use history management system including at least two components out of a plurality of modalities and a server. The modality generates an image for medical treatment and simultaneously generates use history information of the image. The modality and/or the server store the use history information so as to be associated with the corresponding image.

Another aspect of the invention provides a modality including: an image generating unit for generating an image for medical treatment; a use history information generating unit for generating use history information including generation date/time information of the image generated by the image generating unit; and a storing unit for storing the use history information generated by the use history information generating unit so as to be associated with the image generated by the image generating unit.

Further aspect of the invention also provides a server including: a storing unit for storing an image for metical treatment and use history information of the image; a communication unit for controlling communication performed via a network and transmitting the image to another modality or server; and a control unit. When the communication unit transmits the image to another modality or server, the control unit adds destination information specifying the modality or server to which the image was transmitted to use history information corresponding to the image stored in the storing unit, and stores the resultant information to the storing unit.

According to the invention, the image use history management system, the modality, and the server in which each time an image is used, information of the use is added to the use history information can be provided.

Further objects and advantages of the present invention will be apparent from the following description of the preferred embodiments of the invention as illustrated in the accompanying drawings.

### BRIEF DESCRIPTION OF DRAWINGS

FIG. 1 is a diagram showing the configuration of an image use history information management system 100 of an embodiment.

FIG. 2 is a diagram showing an example of the configuration of a modality 1.

FIG. 3 is a diagram showing an example of the configuration of a server 2.

### DETAILED DESCRIPTION OF THE INVENTION

An embodiment of the invention will be described hereinbelow.

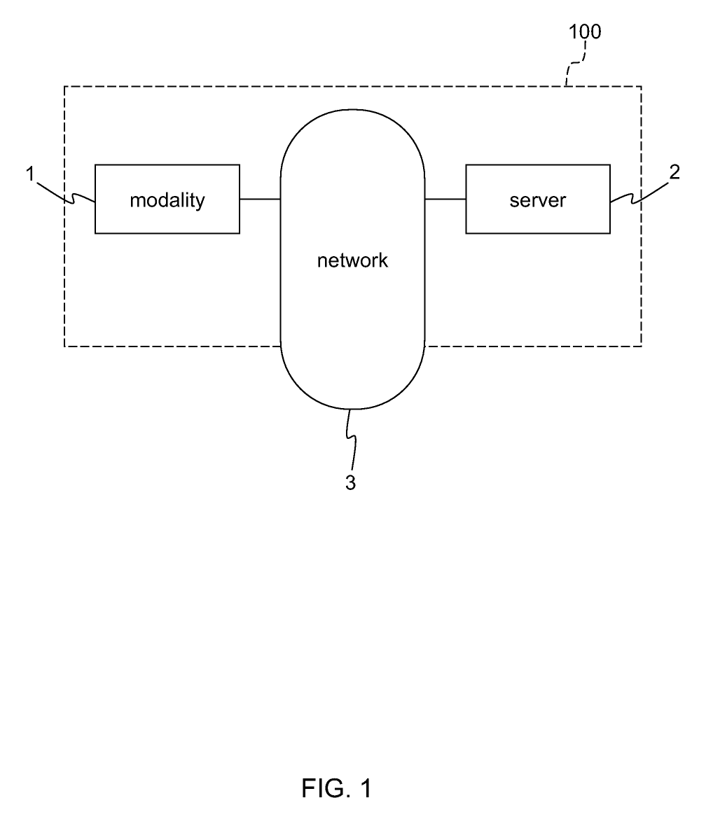

FIG. 1 is a diagram showing the configuration of an image use history information management system of the embodiment.

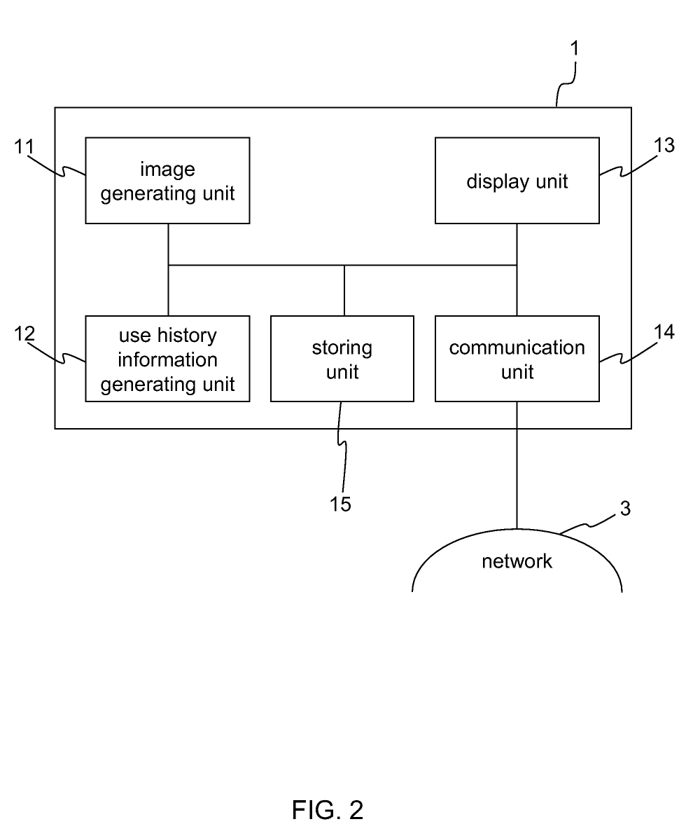

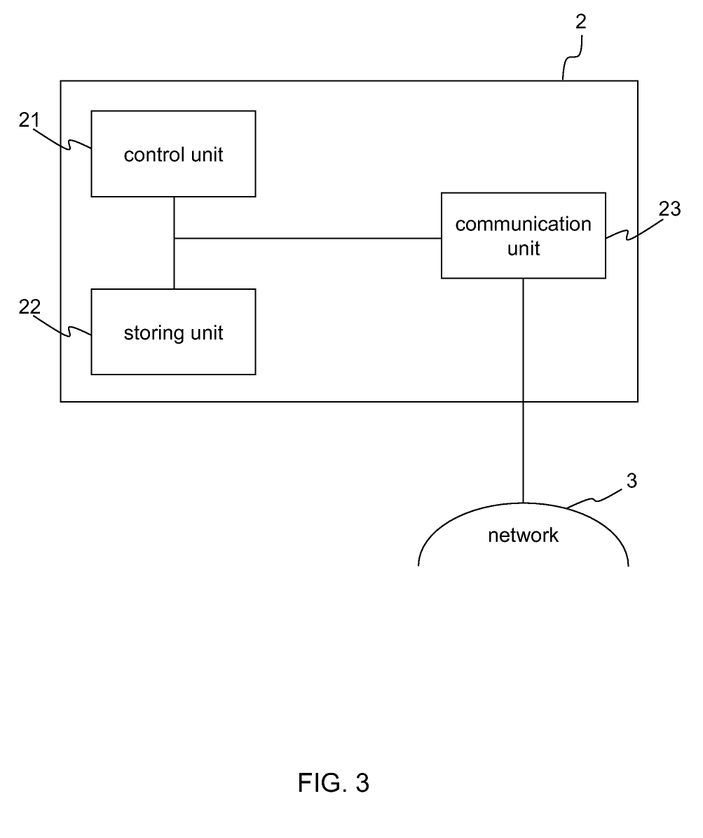

As shown in FIG. 1, the image use history information management system 100 has a modality 1 and a server 2 which are communicatably connected to each other via a network 3. FIG. 2 is a diagram showing an example of the configuration of the modality 1. FIG. 3 is a block diagram showing the configuration of the server 2.

The modality 1 is an apparatus for capturing an image of a patient and generating an image for medical treatment. Examples of the modality 1 are an MRI apparatus, a CT apparatus, and an ultrasonic diagnostic apparatus. As described later, the modality 1 has a storing unit for storing use history information associated with the image. The details of the use history information will be described later.

The number of modalities included in the image use history information management system 100 may be arbitrary, and the kinds of the modalities are not also limited. Specifically, for example, one MRI apparatus may be included as the modality in the image use history information management system 100, or an MRI apparatus, a CT apparatus, an ultrasonic diagnostic apparatus, and other modalities may be included. An image generated by the modality 1 is, for example, an image conformed with the DICOM (Digital Imaging and Communications in Medicine) standard, and includes the personal information and test information of a patient (hereinbelow, called patient information).

The server (server device) 2 is connected to the modality 1 via the network 3. The server 2 receives an image generated by the modality 1 and patient information or transmits an image in response to an image viewing request from another server or modality, an image viewing terminal, or the like. The server 2 records an image to an external recording device (for example, an optical disk such as DVD or MO, an HDD having the RAID configuration, or the like).

As shown in FIG. 3, the server 2 has a storing unit 22. In the case where an image is transmitted to another server or modality, an image viewing terminal, or the like or in the case where an image is recorded in an external recording device, the server 2 stores use/record information which will be described later so as to be associated with the transmitted image into the storing unit 22.

A terminal device is connected to the modality 1 and the server 2. The terminal device is used by a medical care professional or the like to retrieve/view an image for medical treatment, or by an administrator having the right to manage the image use history information management system 100 to perform managing works such as correction and edition of image use history information and patient information. The terminal device is connected to the serer 2 and the modality 1 via the network 3.

The image use history information management system 100 is connected to a second image use history information management system (not shown) via the network 3.

The image use history information management system 100 of the embodiment has the configuration including one modality 1 and one server 2 as shown in FIG. 1, but the invention is not limited to the configuration. That is, it is sufficient for the image use history information management system 100 to include at least one of the modality 1 and the server 2.

The use history information will be described below.

The use history information is information indicating how an image was used in the modality 1 or the server 2. To be specific, in the case of the modality 1, the use history information is use information of an image after it was generated or after the image was received from another modality or the server 2. In the case of the server 2, the use history information is image use information since an image is received from another modality 1 or the server 2.

The user history information includes image generation date/time information, generation source information, generation worker information, transmission date/time information, destination information, transmitter information, transmission worker information, information of date and time of recording to the external recording medium, recording worker information, recording medium information, erase date/time information, and anonymization information.

The information will be described in detail hereinbelow.

The generation date/time information is information generated when the modality 1 generates an image, and is information of date and time of generation of an image.

The generation source information is information of the modality 1 which generated an image, such as the serial number of the modality 1 which generated an image, the number in the image use history information management system 100, or the like.

The generation worker information is information of the user who executed a generating work and is, for example, the name, ID number, or the like of a medical care professional who does an image generation work.

The transmission date/time information is information of date and time when an image is transmitted. The destination information is information of a destination to which an image is transmitted, that is, the same information as the transmission requester. The transmitter information is information of a transmitter that sends an image, that is, the modality 1 or the server 2 that sends an image. The transmission worker information is information of the user such as a medical care professional who executes the transmitting work (transmits a transmission request).

The recording date/time information, recording worker information, and recording medium information is information in the case where the server 2 records an image to an external recorder and is information of date and time when recording is executed, information of the user who executes a recording work, and information of an external recording medium on which recording is performed (for example, volume label of a magnetic disk or an optical disk, volume label of an HDD, or the like), respectively.

The erase date/time information is information of date and time of erase when an image is erased. There are the cases where an image is erased; the case where, for example, the modality 1 erases an image generated by itself, and the case where the modality 1, the server 2, and/or a second server (not shown) of the second image use history information management system (not shown) erases an image transmitted from another modality 1 or server 2.

The anonymization information is information indicating that patient information included in an image is erased.

Recording modes, recording methods, and the like of the information are not limited in the invention.

Next, the configuration of the modality 1 of the embodiment will be described.

FIG. 2 is a diagram showing an example of the configuration of the modality 1.

As described above, the modality 1 is an MRI apparatus, a CT apparatus, an ultrasonic diagnostic apparatus, or a medical device capable of generating a medical image. As shown in FIG. 2, modality 1 has an image generating unit 11, a use history information generating unit 12, a display unit 13, a communication unit 14, and the storing unit 15.

The image generating unit 11 generates an image of a subject and, simultaneously, embeds patient information as test information and personal information of the patient into the generated image. An image generated by the image generating unit 11 is, for example, an image conformed with the DICOM standard. In an image of the DICOM standard, patient information can be written.

The use history information generating unit 12 generates use history information of an image generated by the image generating unit 11 and stores the use history information so as to be associated with the image into the storing unit 15. The use history information at this time point includes generation date/time information, generation source information, and generation worker information.

The display unit 13 is a display device constructed by a CRT (Cathode Ray Tube), an LCD (Liquid Crystal Display), or the like and displays the image generated by the image generating unit 11, the use history information generated by the use history information generating unit 12 and associated with the image, and the like.

The communication unit 14 is connected to the network 3 and transmits the image generated by the image generating unit 11 to the server 2. At the time of transmitting an image and use history information to a requester which requests for transmission of an image such as another modality 1 or the server 2, the communication unit 14 adds destination information to the use history information associated with the image to be transmitted, and stores the resultant information to the storing unit 15. As information to be added to the use history information, not only the destination information but transmission date/time information, transmitter information, transmission worker information, or the like may be added.

Further, the communication unit 14 can inquire another modality 1 or the server 2 about use history information. By making an inquiry about use history information, how the image was used in another modality 1 and the server 2 can be grasped.

On the contrary, when an inquiry about the use history information is received from another modality 1 or the server 2, the communication unit 14 transmits the requested use history information to the requester.

The storing unit 15 stores an image generated by the image generating unit 11 and use history information related to the image.

Next, the configuration of the server 2 will be described.

FIG. 3 is a block diagram showing the configuration of the server 2.

As shown in FIG. 3, the server 2 has a control unit 21, the storing unit 22, and a communication unit 23.

The control unit 21 is constructed by a CPU (Central Processing Unit) or the like, reads a program stored in the storing unit 22, and performs a general control of the server 2.

The storing unit 22 is a storing medium such as an HDD (Hard Disk Drive) or ROM (Read Only Memory), and stores an image transmitted from the modality 1 via the communication unit 23 and use history information as information indicating how the image was used in the server 2 together with the program executed by the control unit 21. At the time of transmitting an image in response to a request from another modality 1 or the server 2, the communication unit 23 adds destination information to the use history information associated with the image to be transmitted, and overwrites the information. Not only the destination information but also transmission date/time information, transmitter information, transmission worker information, and the like may be added to the use history information.

The communication unit 23 is connected to the network 3, receives an image transmission request from another modality 1 or the server 2, and transmits a requested image to the requester via the network 3. Alternatively, the communication unit 23 transmits an image transmission request to another modality 1 or the server 2, and receives an image.

Further, the communication unit 23 can inquire another modality 1 or the server 2 about use history information. By making an inquiry about use history information, how the image was used in another modality 1 and the server 2 can be grasped.

On the contrary, when an inquiry about the use history information is received from another modality 1 or the server 2, the communication unit 23 transmits the requested use history information to the requester.

As described above, in the image use history information management system 100 of the embodiment, at the time of generating an image, the modality 1 generates use history information of the image. When the image is subject to a process such as transmission of the image, erasure of the image, recording of the image to an external recording medium, or erasure of patient information from the image, the modality 1 and the server 2 additionally write information corresponding to the process to the use history information and store the overwritten information so as to be associated with the image, so that the image use history can be stored. When use history information is requested for another modality 1 or the server 2, how the image was used in another modality 1 or the server 2 can be known. By repeating the operation, the use history of one image can be even traced, and the places where the image was used until now can be easily known. Since the use history of a specific image can be easily managed in the image use history information management system 100, leakage of images can be prevented.

In the case where the server 2 erases personal information from an image, information of the erasure is additionally written in the use history information. Consequently, there is also an effect of preventing leakage of personal information of a patient.

Further, also in the case where an image is transmitted to the modality 1 and the second server of the second image use history information management system connected via the network 3, the information of the transmission is additionally written in the use history information. Consequently, the use history of an image is managed strictly, and there is an effect of preventing leakage of an image to the outside.

In the case of transmitting an image to the second image use history information management system, to determine whether the second image use history information management system is a reliable party and an image can be transmitted or not, when the modality 1 or the server 2 receives a transmission request from the second image use history information management system, the second image use history information management system may be authenticated. In this case, for example, an authentication unit is further provided for the modality 1 or the server 2 to authenticate the second image use history information management system. An existing technique can be used for the authenticating method, and the authenticating method is not limited in the invention.

As described above, in the image use history information management system 100 of the embodiment, even in the case where a plurality of modalities 1 and servers 2 are included in the image use history information management system 100, a disadvantage such that an image is transmitted among a number of servers and terminal devices and it is not known where the image is used can be solved.

The invention is not limited to the foregoing embodiment.

At the time of carrying out the invention, the components of the foregoing embodiment may be variously changed, combined, sub-combined, or replaced within the technical scope of the invention or equivalent range.

Although the image use history information management system 100 of the foregoing embodiment has the configuration that a request for transmitting an image is addressed without authentication in the system, in the invention, a transmission request may be addressed after performing authentication. The authentication is personal authentication or the like using the ID number of the user who transmits a transmission request or a preset password. In this case, it is sufficient to employ a configuration that the modality 1 or the server 2 further has an authentication unit and an authenticating process is performed. The authenticating method is not limited in the invention. For example, an existing authentication technique can be used.

Although it has been described that the image use history information management system 100 is connected to the second image use history information management system via the network 3, the system 100 may not be connected to the second system. The image use history information management system 100 may be connected to, for example, an independent terminal device or the like (which is not included in the image use history information management system) and send an image in response to a transmission request of the terminal device or the like. In this case, to determine whether or not an image may be transmitted to the terminal device or the like, it is preferable to authenticate the terminal device or the like. An existing authenticating technique can be used as the method of authentication, and the authenticating method is not limited in the invention.

Although the case where the modality 1 only generates and stores an image and use history information in the image use history information management system 100 of the foregoing embodiment has been described, the invention is not limited to the case. For example, like the server 2, the modality 1 may record an image to an external recording medium.

In the above-described image use history information management system 100, each of the modalities 1 and the server 2 as the components stores the use history information. For example, the image use history information management system 100 may further include a host (not shown) to manage the use history information of all of the modalities 1 and the server 2 in a centralized manner. In this case, each time use history information is newly generated or updated, each of the modalities 1 and the server 2 transmits the use history information to the host.

Although an image and use history information corresponding to the image is different information and handled separately in the foregoing embodiment, for example, transfer history information indicating how an image was transmitted/transferred may be included in the image. In this case, information described as the use history information in the foregoing embodiment is included as the transfer history information in an image, so that the modality 1 or server that stores the image can view how the image has been transferred. In this case, for example, it is sufficient to record the transfer history information in a DICOM private tag in an image of the DICOM standard.

Many widely different embodiments of the invention may be configured without departing from the spirit and the scope of the present invention. It should be understood that the present invention is not limited to the specific embodiments described in the specification, except as defined in the appended claims.

1. An image use history management system comprising at least two components out of a plurality of modalities and a server,
wherein the modality generates an image for medical treatment and simultaneously generates use history information of the image, and
the modality and/or the server store the use history information so as to be associated with the corresponding image.

2. The image use history management system according to claim 1, wherein the use history information generated by the modality upon generation of an image includes at least one of generation date/time information, generation source information that specifies the modality which generated the image, and generation worker information of a worker who generated the image.

3. The image use history management system according to claim 1, wherein when the image is used, the modality and/or the server add information of the use to the use history information associated with the image.

4. The image use history management system according to claim 2, wherein when the image is used, the modality and/or the server add information of the use to the use history information associated with the image.

5. The image use history management system according to of claim 1, wherein when an image is transmitted to another modality or server, the modality and/or the server add destination information that specifies the modality or server to which the image is transmitted to the use history information associated with the image.

6. The image use history management system according to claim 2, wherein when an image is transmitted to another modality or server, the modality and/or the server add destination information that specifies the modality or server to which the image is transmitted to the use history information associated with the image.

7. The image use history management system according to claim 3, wherein when an image is transmitted to another modality or server, the modality and/or the server add destination information that specifies the modality or server to which the image is transmitted to the use history information associated with the image.

8. The image use history management system according to claim 1, wherein an image is recorded on an external recording device, the modality and/or the server add recording medium information as information specifying the medium on which the image was recorded.

9. The image use history management system according to claim 2, wherein an image is recorded on an external recording device, the modality and/or the server add recording medium information as information specifying the medium on which the image was recorded.

10. The image use history management system according to claim 3, wherein an image is recorded on an external recording device, the modality and/or the server add recording medium information as information specifying the medium on which the image was recorded.

11. The image use history management system according to claim 4, wherein an image is recorded on an external recording device, the modality and/or the server add recording medium information as information specifying the medium on which the image was recorded.

12. The image use history management system according to claim 1, wherein the modality generates an image while embedding personal information of a patient as an object of imaging into the image, and
at the time of erasing the personal information from the image, the modality and/or the server add anonymization information indicating that the personal information is erased to the use history information corresponding to the image.

13. The image use history management system according to claim 1, further comprising a host for managing, in a centralized manner, use history information stored in the modality and/or the server.

14. The image use history management system according to claim 1, wherein the modality and/or the server send an inquiry about the use history information to another modality and/or another server.

15. The image use history management system according to claim 1, wherein when an inquiry about the use history information is received from another modality and/or another server, the modality and/or the server transmit the use history information to another modality and/or another server.

16. A modality comprising:
an image generating unit for generating an image for medical treatment;
a use history information generating unit for generating use history information including generation date/time information of the image generated by the image generating unit; and
a storing unit for storing the use history information generated by the use history information generating unit so as to be associated with the image generated by the image generating unit.

17. The modality according to claim 16, further comprising:
a communication unit for transmitting/receiving an image to/from another modality or a server connected via a network,
wherein when the communication unit transmits an image to another modality or server, the use history information generating unit adds destination information specifying the modality or server to which the image was transmitted to use history information corresponding to the image stored in the storing unit.

18. A server comprising:
a storing unit for storing an image for metical treatment and use history information of the image;
a communication unit for controlling communication performed via a network and transmitting the image to another modality or server; and
a control unit,
wherein when the communication unit transmits the image to another modality or server, the control unit adds destination information specifying the modality or server to which the image was transmitted to use history information corresponding to the image stored in the storing unit, and stores the resultant information to the storing unit.

19. The server according to claim 18, wherein when an image is recorded on an external recording device, the control unit adds recording medium information as information specifying the medium on which the image was recorded and stores the resultant information to the storing unit.

20. The server according to claim 18, wherein at the time of erasing an image in which personal information of a patient as an object of imaging is embedded at the time of generation, and at the time of erasing the personal information from the image, the control unit adds anonymization information indicating that the personal information is erased to the use history information corresponding to the image, and stores the resultant information to the storing unit.
